(19) United States
(12) Patent Application Publication
(10) Pub. No.: US 2014/0057164 A1
(43) Pub. Date: Feb. 27, 2014

(54) ENHANCED CARBON BASED ELECTRODE FOR USE IN ENERGY STORAGE DEVICES

(71) Applicant: FASTCAP SYSTEMS CORPORATION, (US)

(72) Inventors: Nicolo M. Brambilla, Boston, MA (US); Riccardo Signorelli, Boston, MA (US); Jamie Beard, Cambridge, MA (US)

(73) Assignee: FASTCAP SYSTEMS CORPORATION, Boston, MA (US)

(21) Appl. No.: 13/886,177

(22) Filed: May 2, 2013

Related U.S. Application Data
(60) Provisional application No. 61/641,682, filed on May 2, 2012.

(51) Int. Cl. H01G 11/36; H01M 4/04; H01M 4/66

(52) U.S. Cl. CPC H01G 11/36; H01M 4/663; H01M 4/0404
USPC 429/211; 427/113; 427/596; 361/502

(57) ABSTRACT

The present invention provides an enhanced electrode for an energy storage device, comprising a current collector and nanoform carbon, with active material disposed thereon. In particular embodiments, the present invention also provides energy storage devices comprising the enhanced electrodes of the invention, as well as techniques for fabrication.

### RELATED APPLICATIONS

This application claims the benefit of priority from U.S. Provisional Patent Application No. 61/641,682 filed on May 2, 2012, the entirety of which is incorporated herein by reference.

### STATEMENT OF FEDERALLY SPONSORED RESEARCH

This invention was made with government support under grant DE-AR0000035/0001 awarded by the Unites States Department of Energy (ARPA-E). The United States government has certain rights in the invention.

### BACKGROUND OF THE INVENTION

1. Field of the Invention

The present invention relates to highly efficient and/or high power electrodes comprising various nanoforms of carbon, as well as to methods and apparatus for producing these electrodes.

2. Description of the Related Art

Carbon nanotubes (hereinafter referred to as “CNTs”) are carbon structures each structured such that a carbon sheet composed of a planar hexagonal arrangement of carbon atoms is sealed in a cylindrical shape, which have been shown to exhibit a variety of advantageous properties. Many of the properties suggest opportunities for improvements in a variety of technology areas, such as electronic device materials, optical materials as well as conducting and other materials. Similarly, other nanoforms of carbon exhibit promising characteristics in these same areas. For example, CNTs and other nanoforms are proving to be useful for energy storage in capacitors.

However, construction of electrodes that include CNT and other nanoforms of carbon remains a challenge. That is, while work in the labs, in small scale environments, may produce electrodes with promising characteristics, many techniques used to provide these electrodes are not scalable into a production environment.

As such, there is a need for methods and apparatus for production of a high power electrode based on carbon nanotubes, and other carbon nanoforms. Preferably, the methods and apparatus would be simple to perform, and thus offer reduced cost of manufacture, as well as an improved rate of production.

### SUMMARY OF THE INVENTION

The present invention provides enhanced electrodes, based on carbon nanotubes, and other carbon nanoforms, as well as the methods and apparatus for preparing these enhanced electrodes. In general, the enhanced electrodes of the present invention comprise nanoform carbon with an active material disposed onto or into the nanoform carbon. In addition, the present invention provides devices incorporating these electrodes.

Accordingly, one aspect of the present invention provides an enhanced electrode for an energy storage device, the electrode comprising: a current collector disposed over a base layer of nanoform carbon, e.g., wherein the nanoform carbon is vertically aligned carbon nanotubes (VCNT); and an active material disposed on or in the base layer.

In another aspect the invention provides a method for fabricating an enhanced electrode. The method comprises the steps of: selecting an electrode comprising a current collector disposed over a base layer of nanoform carbon, e.g., wherein the nanoform carbon is vertically aligned carbon nanotubes (VCNT); and disposing an active material onto or into the base layer, such that an enhanced electrode is fabricated.

In yet another aspect, the present invention provides an energy storage device comprising an enhanced electrode, the electrode comprising: a current collector disposed over a base layer of nanoform carbon, e.g., wherein the nanoform carbon is vertically aligned carbon nanotubes (VCNT); and an active material disposed on or in the base layer.

Another aspect of the present invention provides a method of fabricating an energy storage device comprising the steps of selecting an enhanced electrode of any one of claims 1 to 9; and disposing said electrode in an energy storage device to function as an electrode for the energy storage device, such that the energy storage device is fabricated.

### BRIEF DESCRIPTION OF DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings. The accompanying figures are schematic and are not intended to be drawn to scale. In the figures, each identical or nearly identical component illustrated is typically represented by a single numeral. For purposes of clarity, not every component is labeled in every figure, nor is every component of each embodiment shown where illustration is not necessary to allow those of ordinary skill in the art to understand the invention. In the figures:

FIG. 1 is a block diagram depicting an electrode having a carbon base layer disposed onto a current collector;

FIG. 2 is a block diagram depicting an apparatus for depositing active material onto and into the carbon base layer of the electrode of FIG. 1 to provide a high power electrode; and

FIG. 3 is a flow chart providing an exemplary process for providing the high power electrode.

### DETAILED DESCRIPTION OF THE INVENTION

The present invention provides an enhanced electrode for an energy storage device, comprising a current collector having a base layer of nanoform carbon, with active material disposed thereon. In particular embodiments, the present invention also provides energy storage devices comprising the enhanced electrodes of the invention, as well as techniques for fabrication.

The present invention, including the electrodes, methods of use thereof, as well as the related methods and apparatus of fabrication will be described with reference to the following definitions that, for convenience, are set forth below. Unless otherwise specified, the below terms used herein are defined as follows:

### I. DEFINITIONS

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including,” “has” and “having” are intended to be inclusive such that there may be additional elements other than the listed elements.

The language “and/or” is used herein as a convention to describe either “and” or “or” as separate embodiments. For example, in a listing of A, B, and/or C, it is intended to mean both A, B, and C; as well as A, B, or C, wherein each of A, B, or C is considered a separate embodiment, wherein the collection of each in a list is merely a convenience. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The language “active material” is used to describe the part of the electrode with the electrochemical properties that provide energy storage in a device such as a battery. The active material of the present invention is disposed on or in the nanoform carbon, incorporating advantages, e.g., structural advantages, of the nanostructure surface area of this material. In certain embodiments, the active material is a high-performance, high-capacity material selected from the non-limiting list of example materials: Manganese Oxide (Mn₂O₄), Vanadium Oxide (V₂O₅), Nickel Cobalt Aluminum (NCA), Core Shell Gradient (CSG), Spinel-based lithium-ion (LMO), Lithium Iron Phosphate (LFP), Cobalt-based lithium-ion (LCO), Nickel Cobalt Manganese (NCM), or any combination thereof.

“Energy density” is one half times the square of a peak device voltage times a device capacitance divided by a mass or volume of said device

In general, the term “electrode” is art recognized and refers to an element comprising an electrical conductor, the electrode normally being used to make contact or otherwise communicate with another material which is often non-metallic.

The language “energy storage device” is art-recognized to describe a device that stores energy for later use. Non-limiting examples include batteries, capacitors, hybrid capacitors, and ultracapacitors. Non-limiting examples of battery types include lithium ion, magnesium ion, lead acid, nickel cadmium, metal air, and alkaline.

As a matter of convention, the terms “internal resistance” and “effective series resistance” and “ESR”, terms that are known in the art to indicate a resistive aspect of a device, are used interchangeably herein.

The language “nanoform carbon” is used herein to describe the general class of allotropes of carbon, which, for example, include but are not limited to nanotubes (single or multi-walled) nanohorns, nano-onions, carbon black, fullerene, graphene, and oxidized graphene. In certain embodiments of the invention the nanoform carbon is a nanotube, e.g., vertically aligned carbon nanotubes.

The term “ultracapacitor” as used herein, describes an energy storage device exploiting art-recognized electric double layer capacitance mechanisms.

As a matter of convention, it should be considered that the term “may” as used herein is to be construed as optional; “includes” is to be construed as not excluding other options (i.e., steps, materials, components, compositions, etc,); “should” does not imply a requirement, rather merely an occasional or situational preference. Other similar terminology is likewise used in a generally conventional manner.

### II. ENHANCED ELECTRODES

The present invention provides methods and apparatus for providing an enhanced electrode for an energy storage system/device. In general, the electrode includes at least one layer of nanoform carbon, e.g., vertically aligned carbon nanotube aggregate (VCNT). In certain embodiments, the electrode may be fabricated from mass-produced VCNT, and therefore exhibits, among other things, higher gravimetric power density (power as a function of weight) and volumetric power density (power as a function of volume) than previously achievable. Further, the electrode exhibits a low internal resistance and can be fabricated to provide high voltages (of about four or more volts).

In addition, the electrodes of the present invention comprise an active material disposed onto or into the nanoform carbon layer. The addition of the active material onto or into the nanoform carbon layer, imparts enhanced properties to the resulting electrode due, in part, to the underlying increased surface area of the carbon nanoform layer, the improved contact resistance between the carbon nanoform layer and the current collector, and the translation of these properties to the active material (i.e., as compared to electrodes without the combination of this active material with the nanoform carbon layer). Such enhanced properties may be selected from one or more of the following: improved conductivity, reduced internal resistance, improved gravimetric power density, improved volumetric power density, increased voltage delivery, improved efficiency, increased energy storage capacity, improved power delivery, and improved performance in a given environment. For example, enhanced properties for an aluminum ion battery of the present invention may include: an energy density of 300-500 Wh/kg, or a power density of 40-50 kW/kg. In certain embodiments, the active material may be selected from Manganese Oxide (Mn2O4), Vanadium Oxide (V2O5), Nickel Cobalt Aluminum (NCA), Core Shell Gradient (CSG), Spinel-based lithium-ion (LMO), Lithium Iron Phosphate (LFP), Cobalt-based lithium-ion (LCO) Nickel Cobalt Manganese (NCM); and any combination thereof. In certain embodiments, the nanoform carbon is configured according to a property of the active material.

Accordingly, one embodiment the present invention provides an enhanced electrode for an energy storage device, e.g., a battery or an ultracapacitor, the electrode comprising: a current collector disposed over a base layer of nanoform carbon, e.g., wherein the nanoform carbon is vertically aligned carbon nanotubes (VCNT); and an active material disposed on or in the base layer.

In certain embodiments, other nanoforms of carbon that may be included, or used in place of the VCNT in the base layer 10 include, without limitation, nanohorns, nano-onions, carbon black, fullerene, graphene, oxidized graphene, combinations thereof, and various treated forms of the foregoing. In certain embodiments, the nanoform carbon further includes metal nano-particles, metal oxide nano-particles, and/or at least one form of conductive polymer.

In certain embodiments, the nanoform carbon is vertically aligned carbon nanotubes (VCNT). Moreover, in order to provide some context for the teachings herein, reference is made to U.S. Pat. No. 7,897,209, entitled “Apparatus and Method for Producing Aligned Carbon Nanotube Aggregate,” incorporated herein by reference, in its entirety. The foregoing patent (the “'209 patent”) teaches a process for producing aligned carbon nanotube aggregate.” Accordingly, the teachings of the '209 patent, which are but one example of techniques for producing nanoform carbon such as aligned carbon nanotube aggregate, may be used to produce carbon nanotube aggregate (CNT) referred to herein.

In an exemplary embodiment, the base layer 10 is formed of vertically aligned carbon nanotubes (VCNT), and may include single wall nanotubes and/or multi-wall nanotubes. Certain suitable non-limiting techniques for providing the VCNT are provided in the '209 patent.

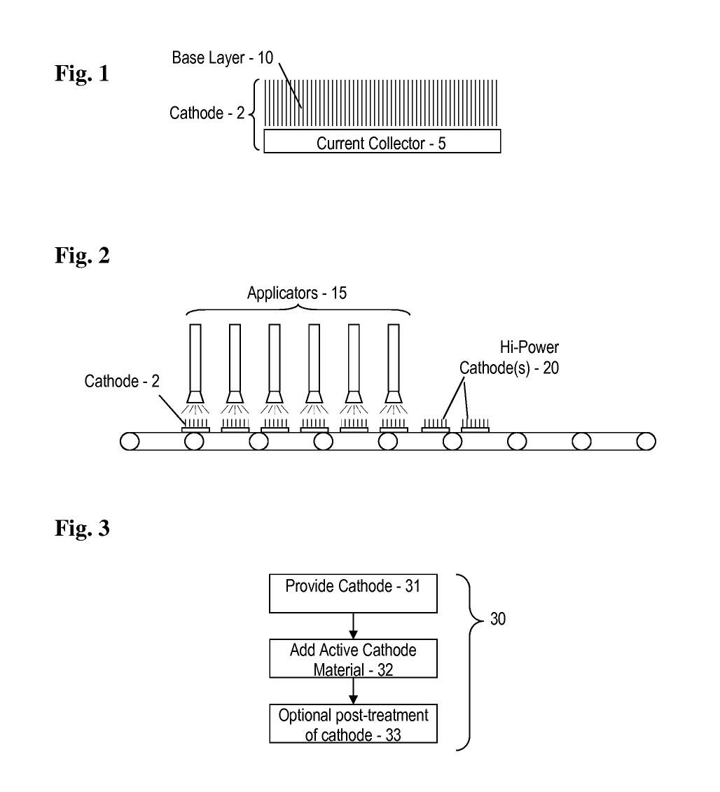

Referring now to FIG. 1, an embodiment of an electrode 2 is shown. In this non-limiting example, the electrode 2 includes a current collector 5 and a base layer 10. In some embodiments, the current collector 5 is between about 0.5 micrometers (μm) to about 100 micrometers (μm) thick.

In certain embodiments, the current collector 5 may appear as a thin layer, e.g., as applied by chemical vapor deposition (CVD), sputtering, e-beam, thermal evaporation or through another suitable technique. In certain embodiments, the current collector 5 is selected for its properties such as conductivity, being electrochemically inert and compatible with the base layer 10. In certain embodiments, the current collector 5 is a metal foil. In particular embodiments, exemplary materials include aluminum, platinum, gold, tantalum, titanium, copper, nickel, any alloy thereof, and may include other materials as well as various alloys. In a specific embodiment, the current collector 5 is Aluminum foil.

By designing and then applying the current collector 5 to the VCNT, it is possible to provide high conductivity in the electrode 2, as well as desired physical properties, such as enhanced flexibility and enhanced surface area of the electrode 2.

In certain embodiments, the vertically aligned carbon nanotubes (VCNT) are grown on a substrate which may include a catalyst disposed thereon. In certain embodiments, the substrate can be used as current collector 5. In other embodiments, once the VCNT is prepared, the VCNT are harvested from the substrate (e.g., and catalyst). The current collector 5 may then be applied to the VCNT, which will form the base layer 10 of the electrode 2.

In certain embodiments, the enhanced electrodes of the present invention possess improved conductivity as compared to electrodes without active material.

In certain embodiments, the enhanced electrodes of the present invention possess improved gravimetric power density as compared to electrodes without active material.

In certain embodiments, the enhanced electrodes of the present invention possess reduced internal resistance as compared to electrodes without active material.

In certain embodiments, the enhanced electrodes of the present invention possess improved volumetric power density as compared to electrodes without active material.

In certain embodiments, the enhanced electrodes of the present invention possess increased voltage delivery as compared to electrodes without active material.

### III. METHOD OF FABRICATION

In another embodiment the invention provides a method for fabricating an enhanced electrode of the present invention. The method comprises the steps of: selecting an electrode comprising a current collector disposed over a base layer of nanoform carbon, e.g., wherein the nanoform carbon is vertically aligned carbon nanotubes (VCNT); and disposing an active material onto or into the base layer, such that an enhanced electrode is fabricated.

A variety of techniques may be used to prepare or fabricate electrode 2. For example, fabrication may involve varying aspects of the base layer 10. In certain embodiments, morphology of vertically aligned carbon nanotubes (VCNT) may be varied. Aspects of the VCNT that are selected for use in the electrode 2 may be chosen, for example, according to properties of the active material, intended usage and properties of the electrode 2, and the like.

As shown in FIG. 2, once provided with the electrode 2, applicators 15 may be used to apply active material to the base layer 10 of each electrode 2, which results in a high-power electrode 20. It should be recognized that this illustration is simplified, and merely represents application and mass-production of the high-power electrode 20. That is, applying active material may include the use of processes such as chemical vapor deposition (CVD), sputtering, e-beam, thermal evaporation, atomic layer deposition (ALD) or through another suitable technique as deemed appropriate by a user, designer or other similarly situated party.

Exemplary active materials include high-performance, high-capacity materials such as: Manganese Oxide (Mn₂O₄), Vanadium Oxide (V₂O₅), Nickel Cobalt Aluminum (NCA), Core Shell Gradient (CSG), Spinel-based lithium-ion (LMO), Lithium Iron Phosphate (LFP), Cobalt-based lithium-ion (LCO) and Nickel Cobalt Manganese (NCM). Examples of these materials suited for use in fabrication of the electrode are available from Targray Technology International Inc. of Kirkland, QC, and Targray, Inc. of Laguna Niguel, Calif. Combinations of these active materials and others may be used, as well as other active materials altogether.

In certain embodiments, the vertically aligned carbon nanotubes (VCNT) are grown on a substrate. In certain embodiments, the substrate comprises a catalyst disposed thereon. In certain embodiments, the substrate is the current collector. In certain embodiments, the vertically aligned carbon nanotubes (VCNT) are harvested from the substrate, e.g., wherein the current collector is applied to the VCNT, which will form the base layer of the electrode.

In certain embodiments, the current collector is a metal foil. In particular embodiments, the metal foil comprises a metal selected from the group consisting of aluminum, platinum, gold, tantalum, titanium, copper, nickel and any alloy thereof. In a specific embodiment, the metal foil comprises aluminum.

In certain embodiments, the current collector is applied to the nanoform carbon by chemical vapor deposition (CVD), sputtering, e-beam, or thermal evaporation.

In certain embodiments, the step of disposing an active material onto or into the base layer is selected from the group consisting of chemical vapor deposition (CVD), sputtering, e-beam, thermal evaporation, atomic layer deposition (ALD), and any combination thereof.

In certain embodiments, the active material is selected from the group consisting of Manganese Oxide (Mn2O4), Vanadium Oxide (V2O5), Nickel Cobalt Aluminum (NCA), Core Shell Gradient (CSG), Spinel-based lithium-ion (LMO), Lithium Iron Phosphate (LFP), Cobalt-based lithium-ion (LCO) Nickel Cobalt Manganese (NCM); and any combination thereof.

In certain embodiments, the nanoform carbon is configured according to a property of the active material.

In certain embodiments, the enhanced electrode may further treated to provide additional functionality.

Referring now to FIG. 3, an exemplary process 30 for providing the high-power electrode 20 is provided. In a first stage 31, the electrode 2 is selected and provided. In a second stage 32, the active material is applied to the electrode 2. In a third stage 33, the high-power electrode 20 is post treated as necessary for use.

### IV. ENERGY STORAGE DEVICES

In yet another embodiment, the present invention provides an energy storage device comprising an enhanced electrode of the present invention, the electrode comprising: a current collector disposed over a base layer of nanoform carbon, e.g., wherein the nanoform carbon is vertically aligned carbon nanotubes (VCNT); and an active material disposed on or in the base layer.

In certain embodiments, the energy storage device is a battery. Exemplary batteries include aluminum ion, lithium ion, magnesium ion and the like.

In certain embodiments, the energy storage device is an ultracapacitor.

Another embodiment of the present invention provides a method of fabricating an energy storage device comprising the steps of selecting an enhanced electrode of the present invention; and disposing said electrode in an energy storage device to function as an electrode for the energy storage device, such that the energy storage device is fabricated.

One example of a device incorporating an electrode, similarly suitable to those described herein, is provided in U.S. Patent Application Publication No. 2007-0258192, entitled “Engineered Structure for Charge Storage and Method of Making,” incorporated herein by reference, in its entirety.

### EQUIVALENTS

Those skilled in the art will recognize, or be able to ascertain using no more than routine experimentation, numerous equivalents to the specific procedures described herein. Such equivalents were considered to be within the scope of this invention and are covered by the following claims. Moreover, any numerical or alphabetical ranges provided herein are intended to include both the upper and lower value of those ranges. In addition, any listing or grouping is intended, at least in one embodiment, to represent a shorthand or convenient manner of listing independent embodiments; as such, each member of the list should be considered a separate embodiment.

Having disclosed aspects of embodiments of the nanoform carbon electrodes, as well as production apparatus and techniques for fabricating nanoform carbon electrodes, it should be recognized that a variety of embodiments of apparatus and methods may be realized. Accordingly, while the invention has been described with reference to exemplary embodiments, it will be understood by those skilled in the art that various changes may be made and equivalents may be substituted for elements thereof without departing from the scope of the invention. For example, steps of fabrication may be adjusted, as well as techniques for layering, materials used and the like. Many modifications will be appreciated by those skilled in the art to adapt a particular arrangement or material to the teachings of the invention without departing from the essential scope thereof. Therefore, it is intended that the invention not be limited to the particular embodiment disclosed as the best mode contemplated for carrying out this invention.

### INCORPORATION BY REFERENCE

The entire contents of all patents, published patent applications and other references cited herein are hereby expressly incorporated herein in their entireties by reference.

1. An electrode for an energy storage device, the electrode comprising:
a current collector and nanoform carbon, wherein the nanoform carbon comprises vertically aligned carbon nanotubes (VCNT); and
an active material disposed thereon.

2. The electrode of claim 1, wherein the energy storage device is a battery.

3. The electrode of claim 1, wherein the energy storage device is an ultracapacitor.

4. (canceled)

5. The electrode of claim 1, wherein the current collector comprises a metal foil, which comprises a metal selected from the group consisting of aluminum, platinum, gold, tantalum, titanium, copper, nickel and any alloy thereof.

6. The electrode of claim 5, wherein the metal foil comprises aluminum.

7. The electrode of claim 1, wherein the current collector is applied to the nanoform carbon by chemical vapor deposition (CVD), sputtering, e-beam, or thermal evaporation.

8. The electrode of claim 1, wherein the active material is selected from the group consisting of Manganese Oxide (Mn₂O₄), Vanadium Oxide (V₂O₅), Nickel Cobalt Aluminum (NCA), Core Shell Gradient (CSG), Spinel-based lithium-ion (LMO), Lithium Iron Phosphate (LFP), Cobalt-based lithium-ion (LCO) Nickel Cobalt Manganese (NCM), and any combination thereof.

9. The electrode of claim 1, wherein the nanoform carbon is configured according to a property of the active material.

10. A method for fabricating an electrode, the method comprising the steps of:
selecting an electrode comprising a current collector and nanoform carbon, wherein the nanoform carbon comprises vertically aligned carbon nanotubes; and
disposing an active material thereon,
such that an electrode is fabricated.

11. The method of claim 10, wherein the vertically aligned carbon nanotubes are grown on a substrate.

12. The method of claim 10, wherein the substrate comprises a catalyst disposed thereon.

13. The method of claim 10, wherein the substrate is the current collector.

14. The method of claim 10, wherein the vertically aligned carbon nanotubes are harvested from the substrate.

15. The method of claim 14, wherein the current collector is applied to the vertically aligned carbon nanotubes.

16. (canceled)

17. The method of claim 10, wherein the current collector comprises a metal foil, which comprises a metal selected from the group consisting of aluminum, platinum, gold, tantalum, titanium, copper, nickel and any alloy thereof.

18. The method of claim 17, wherein the metal foil comprises aluminum.

19. The method of claim 10, wherein the current collector is applied to the nanoform carbon by chemical vapor deposition (CVD), sputtering, e-beam, or thermal evaporation.

20. The method of claim 10, wherein the step of disposing an active material onto other components of an electrode comprises a method selected from the group consisting of chemical vapor deposition (CVD), sputtering, e-beam, thermal evaporation, atomic layer deposition (ALD), and any combination thereof.

21. The method of claim 10, wherein the active material is selected from the group consisting of Manganese Oxide (Mn₂O₄), Vanadium Oxide (V₂O₅), Nickel Cobalt Aluminum (NCA), Core Shell Gradient (CSG), Spinel-based lithium-ion (LMO), Lithium Iron Phosphate (LFP), Cobalt-based lithium-ion (LCO) Nickel Cobalt Manganese (NCM), and any combination thereof.

22. The method of claim 10, wherein the nanoform carbon is configured according to a property of the active material.

23. An energy storage device comprising an electrode, the electrode comprising:
a current collector and nanoform carbon, wherein the nanoform carbon comprises vertically aligned carbon nanotubes; and
an active material disposed thereon.

24. The energy storage device of claim 23, wherein the energy storage device is a battery.

25. The energy storage device of claim 23, wherein the energy storage device is an ultracapacitor.

26. (canceled)

27. The energy storage device of claim 23, wherein the current collector comprises a metal foil, which comprises a metal selected from the group consisting of aluminum, platinum, gold, tantalum, titanium, copper, nickel and any alloy thereof.

28. The energy storage device of claim 27, wherein the metal foil comprises aluminum.

29. The energy storage device of claim 23, wherein the current collector is applied to the nanoform carbon by chemical vapor deposition (CVD), sputtering, e-beam, or thermal evaporation.

30. The energy storage device of claim 23, wherein the active material is selected from the group consisting of Manganese Oxide (Mn₂O₄), Vanadium Oxide (V₂O₅), Nickel Cobalt Aluminum (NCA), Core Shell Gradient (CSG), Spinel-based lithium-ion (LMO), Lithium Iron Phosphate (LFP), Cobalt-based lithium-ion (LCO) Nickel Cobalt Manganese (NCM), and any combination thereof.

31. The energy storage device of claim 23, wherein the nanoform carbon is configured according to a property of the active material.

32. (canceled)
